(19) United States
(12) Patent Application Publication
(10) Pub. No.: US 2016/0180487 A1
(43) Pub. Date: Jun. 23, 2016

(54) LOAD BALANCING AT A GRAPHICS PROCESSING UNIT

(71) Applicant: Advanced Micro Devices, Inc., Sunnyvale, CA (US)

(72) Inventors: Dawid Trawczynski, Orlando, FL (US); Ken Correll, Fitchburg, MA (US); Stephen D. Presant, San Jose, CA (US); Tushar Shah, West Melbourne, FL (US); Ganesh Chandrasekaran, Orlando, FL (US); Rashad Oreifej, Orlando, FL (US)

(21) Appl. No.: 14/576,828

(22) Filed: Dec. 19, 2014

(51) Int. Cl. G06T 1/20; G06T 15/04

(52) U.S. Cl. CPC G06T 1/20; G06T 15/04; G06T 2200/28

(57) ABSTRACT

A GPU of a processor performers load balancing by enabling and disabling CUs based on the GPU's processing load. A power control module identifies a current processing load of the GPU based on, for example, an activity level of one or more modules of the GPU. The power control module also identifies an expected future processing load of the GPU based on, for example, a number of threads (wavefronts) scheduled to be executed at the GPU. Based on a combination of the current processing load and the expected future processing load, the power control module sets the number of CUs of the GPU that are enabled and the number that are disabled (e.g. clock gated or power gated). By changing the number of enabled CUs based on processing load, the power control module maintains performance at the GPU while conserving power.

### BACKGROUND

1. Field of the Disclosure

The present disclosure relates generally to processors and more particularly to graphics processing units (GPUs).

2. Description of the Related Art

Processors are increasingly used in environments where it is desirable to minimize power consumption. For example, a processor is an important component of computing-enabled smartphones, laptop computers, portable gaming devices, and the like, wherein minimization of power consumption is desirable in order to extend battery life. It is also common for a processor to incorporate a graphics processing units (GPU) to enhance the graphical functionality of the processor. The GPU allows the electronic device to display complex graphics at a relatively high rate of speed, thereby enhancing the user experience. However, the GPU can also increase the power consumption of the processor.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a graphics processing unit (GPU) that can enable and disable compute units (CUs) based on a processing load in accordance with some embodiments.

FIG. 2 is a diagram illustrating enabling and disabling of compute units at the GPU of FIG. 1 based on a processing load in accordance with some embodiments.

FIG. 3 is a block diagram of a power control module of the GPU of FIG. 1 in accordance with some embodiments.

FIG. 4 is a flow diagram of a method of enabling and disabling CUs of a GPU in accordance with some embodiments.

FIG. 5 is a flow diagram of a method of determining whether to enable or disable CUs based on a processing load at a GPU in accordance with some embodiments.

FIG. 6 is a flow diagram illustrating a method for designing and fabricating an integrated circuit device implementing at least a portion of a component of a processing system in accordance with some embodiments.

### DETAILED DESCRIPTION

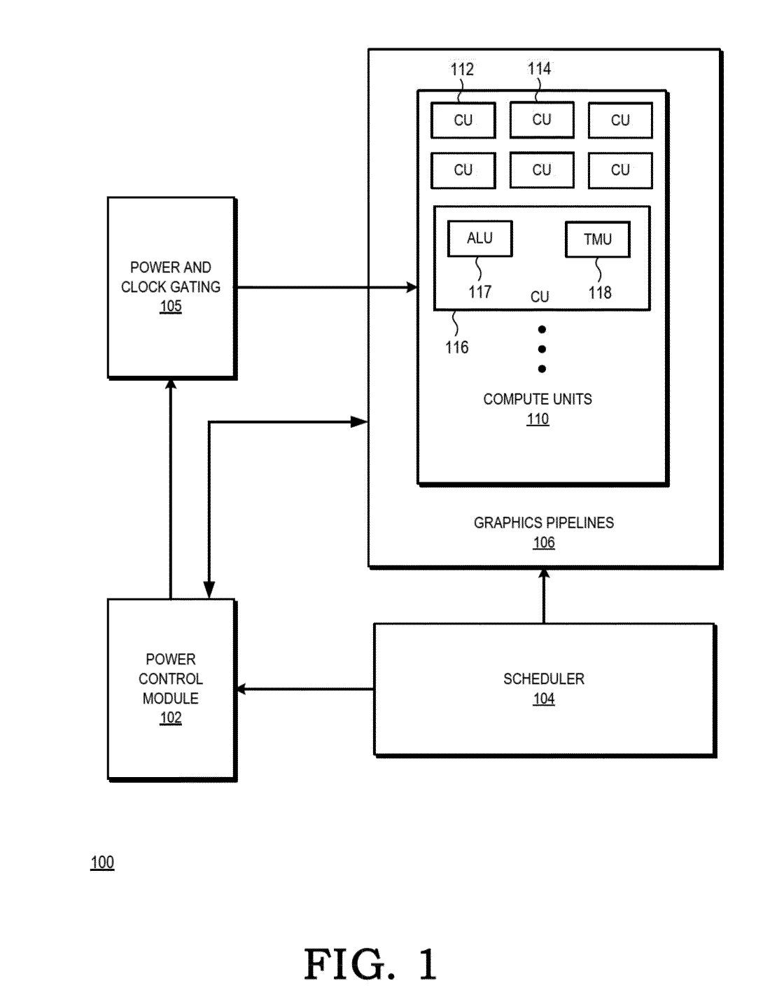

FIGS. 1-6 illustrate techniques for load balancing at a GPU of a processor by enabling and disabling CUs based on the GPU's processing load. A power control module identifies a current processing load of the GPU based on, for example, an activity level of one or more modules of the GPU. The power control module also identifies an expected future processing load of the GPU based on, for example, a number of threads (wavefronts) scheduled to be executed at the GPU. Based on a combination of the current processing load and the expected future processing load, the power control module sets the number of CUs of the GPU that are enabled and the number that are disabled (e.g. clock gated or power gated). By changing the number of enabled CUs based on processing load, the power control module maintains performance at the GPU while conserving power.

In contrast to the techniques disclosed herein, conventional processors can enable or disable the entire GPU based on GPU usage. However, such conventional techniques. can substantially impact performance if, for example, graphics processing is shifted to the central processing unit (CPU) cores when the GPU is disabled. By enabling and disabling individual CUs of the GPU, rather than the entire GPU, the techniques disclosed herein maintain GPU performance While still providing for reduced power consumption under low processing loads.

As used herein, the term “processing load” refers to an amount of work done by a GPU for a given amount of time wherein as the GPU does more work in the given amount of time, the processing load increases. In some embodiments, the processing load includes at least two components: a current processing load and an expected future processing load. The current processing load refers to the processing load the GPU is currently experiencing when the current processing load is measured, or the processing, load the GPU has experienced in the relatively recent past. In some embodiments, the current processing load is identified based on the amount of activity at one or more individual modules of the GPU, such as based on the percentage of idle cycles, over a given amount of time, in an arithmetic logic unit (ALU) or a texture mapping unit (TMU) of the GPU. The expected future processing load refers to the processing load the GPU is expected to experience in the relatively near future. In some embodiments, the expected future processing load is identified based on a number of threads (also referred to as wavefronts), scheduled for execution at the GPU.

FIG. 1 illustrates a block diagram of a GPU 100 in accordance with some embodiments. The GPU 100 can be part of any of a variety of electronic devices, such as a computer, server, compute-enabled portable phone, game console, and the like. Further, the GPU 100 may be coupled to one or more other modules not illustrated at FIG. 1, including one or more general-purpose processor cores at a CPU, memory devices such as memory modifies configured to form a cache, interface modules such as a northbridge or southbridge, and the like.

In the depicted example, the GPU 100 includes a power control module 102, a scheduler 104, a power and clock gating module 105, and graphics pipelines 106. The graphics pipelines 106 are generally configured to execute threads of instructions to perform graphics-related tasks on behalf of an electronic device, including tasks such as texture mapping, polygon rendering, geometric calculations such as the rotation and translation of vertices, interpolation and oversampling operations, and the like. To facilitate execution of the threads, the graphics pipelines 106 include compute units 111. In some embodiments, the graphics pipelines 106 may include additional modules not specifically illustrated at FIG. 1, such as buffers, memory devices (e.g. memory used as a cache or as scratch memory), interface devices to facilitate communication with other modules of the GPU 100, and the like.

Each of the CUs 111 (e.g., CU 116) is generally configured to execute instructions in a pipelined fashion on behalf of the GPU 100. To facilitate instruction execution, each of the CUs 111 includes arithmetic logic units ALU 117) and texture mapping units (e.g. TMU 118). The ALUs are generally configured to perform arithmetic operations decoded from the executing instructions. The TMUs are generally configured to perform mathematical operations related to rotation and resizing of bitmaps for application as textures to displayed objects. Each of the CUs 111 may include additional modules not specifically illustrated at FIG. 1, such as fetch and decode logic to fetch and decode instructions on behalf of the CU, a register file to store data for executing instructions, cache memory, and the like.

Each of the CUs 111 can be selectively and individually placed in any of three power modes: an active mode, a clock-gated mode, and a power-gated mode. In the active mode, power is applied to one or more voltage reference (commonly referred to as VDD) rails of the CU and one or more clock signals are applied to the CU so that the CU can perform its normal operations, including execution of instructions. In the clock-gated mode, the clock signals are decoupled (gated) from the CU, so that the CU cannot perform normal operations, but can return to the active mode relatively quickly and may retain some data in internal flip-flops or latches of the CU. The CU consumes less power in the clock-gated mode than in the active mode. In the power gated mode, power is decoupled (gated) from the one or more voltage reference rails of the CU, so that the CU cannot perform normal operations. In the power-gated mode the CU consumes less power than in the clock-gated mode, but it takes longer for the CU to return to the active mode from the power-gated mode than from the clock-gated mode. For purposes of description, a CU in the active mode is sometimes referred to as an active CU and transitioning the CU to the active mode from another mode is sometimes referred to as activating the CU. For purposes of description, a CU in either of the clock-gated mode or the power gated mode is sometimes referred to as a deactivated CU, and transitioning the CU from the active mode to either of the clock-gated or the power-gated mode is sometimes referred to as deactivating the CU.

The power and clock gating module 105 individually and selectively places each of the CUs 111 into one of the active mode, the clock gated mode, and the power-gated mode based on control signaling received from the power control module 102, as described further below. Thus, the power mode of each of the CUs 111 is individually controllable. For example, at a given point of time the CU 112 can be in the active mode simultaneously with the CU 114 being in the clock-gated mode and the CU 116 being in the power-gated mode. At a later point in time the CU 112 can be in the clock-gated mode simultaneously with the CU being in the active mode and the CU 116 being in the clock gated mode.

In at least one embodiment, the power and clock gating module 105 monitors the amount of time that a CU of the CUs 111 has been in the clock gated mode. When the amount of time exceeds a threshold, the power and clock gating module 105 can transition the CU from the clock-gated mode to the power-gated mode. This allows the power and clock gating module 105 to further reduce power consumption at the CUs 111.

The scheduler 104 is configured to receive requests to execute threads at the GPU 100 and to schedule those threads for execution at the graphics pipelines 106. In sonic embodiments, the requests are received from a processor core in a CPU connected to the GPU 100. The scheduler 104 buffers each received request until one or more of the CUs 111 is available to execute the thread. When one or more of the CUs is available to execute a thread, the scheduler 104 initiates execution of the thread by, for example, providing an address of an initial instruction of the thread to a fetch stage of the CU.

The power control module 102 monitors performance characteristics at the graphics pipelines 106 and at the scheduler 104 to identify a processing load at the GPU 100. Based on the identified processing load, the power control module 102 can send control signaling to the power and clock gating module 105 to set each of the CUs 111 in one of the three power modes. The power control module 102 thereby ensures that there are sufficient CUs in the active mode to execute the processing load while also ensuring that CUs that are not being used, or are being used only lightly, are placed in lower power modes to conserve power.

In some embodiments the power control module 102 identifies a current processing load for each of the CUs 111 by identifying, over a programmable amount of time, the number or percentage of cycles that the ALUs of the CU are stalled and the number or percentage of cycles that the TMUs of the CU are stalled. In addition, the power control module 102 identifies the expected future processing load based on the number of threads, or thread instructions, that are buffered for scheduling at the scheduler 104. The power control module 102 monitors each of these values over time to identify a gradient of the processing load. Based on this gradient, the power control module 102 makes a decision, referred to as an increment or decrement decision, to add (increment) more of the CUs 111 to be in the active mode or to decrease (decrement) the number of CUs 111 in the active mode (and commensurately increase the number of CUs in the clock-gated or power-gated modes).

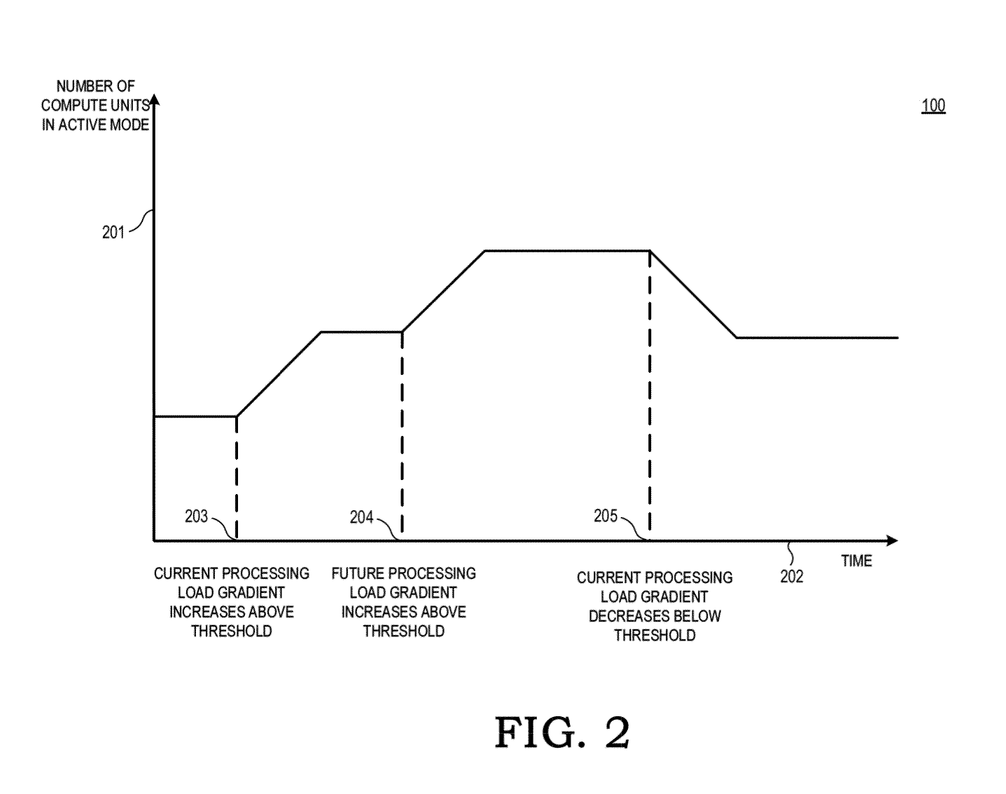

FIG. 2 illustrates a diagram 200 showing activation and deactivation of CUs based on the processing load of the GPU 100 in accordance with some embodiments. The diagram 200 includes a y-axis 201, representing the number of CUs that are in the active mode and an x-axis 202 representing time. At time 203, the power control module 102 identifies that a gradient for the current processing load has increased above a threshold level. In response, the power control module 102 sends control signaling to the power and clock gating module 105 to transition one or more of the CUs 111 from a low-power mode (e.g., the clock-gated mode or the power-gated mode) to the active mode. The power control module 102 thus ensures that one or more additional CUs are available to handle the increased processing load.

At time 204 the power control module 102 identifies that a gradient for the expected future processing load for the GPU 100, as indicated by the number of threads buffered at the scheduler 104, has increased above a corresponding threshold. In response the power control module 102 sends control signaling to the power and clock gating module 105 to transition one or more of the CUs 111 from a low-power mode to the active mode. Subsequently, at time 205, the power control module 102 identifies that the gradient for the current processing load at the GPU 100 has faller below a corresponding threshold. In response to this reduced processing load, the power control module 102 sends control signaling to the power and clock gating module 105 to transition one or more of the CUs 111 from the active mode to a low-power mode (e.g. the clock-gated mode). Thus, the power control module 102 reduces the power consumption of the GPU 100 in response to the reduced processing load.

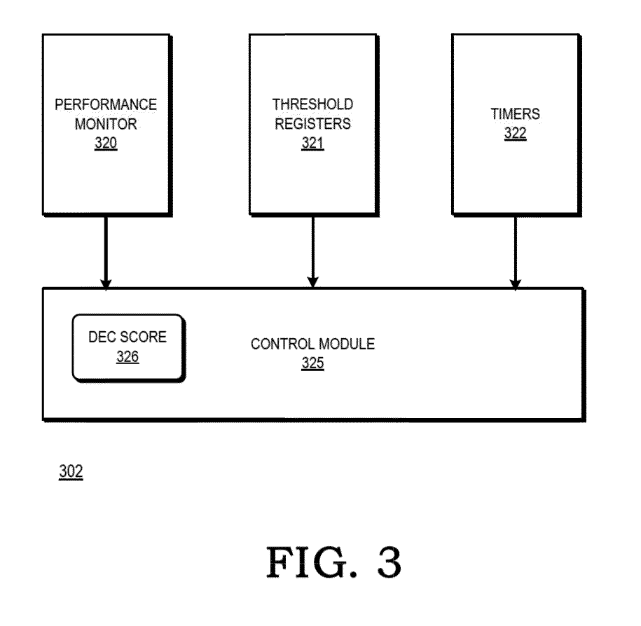

FIG. 3 illustrates a block diagram of the power control module 102 according to some embodiments. In the depicted example, the power control module 102 includes a performance monitor 320, threshold registers 321, timers 322, and a control module 325. The performance monitor 320 is generally configured to monitor performance characteristics at modules of the GPU 100, including the ALUs and TMUs of the CUs 111 (FIG. 1). In some embodiments, the performance monitor 320 includes registers to record values indicative of the performance characteristics, including registers to indicate the number of idle cycles at the ALUs of each of the CUs 111, the number of idle cycles at the TMUs of each of the CUs 111, the number of threads buffered for execution at the scheduler 104 (FIG. 1), and the like. The threshold registers 321 are a set of programmable registers, whereby each register stores a value for a corresponding threshold, including the thresholds used to trigger adjustments in the number of active and inactive CUs, as described further herein. The timers 322 include one or more counters that are periodically adjusted based on a clock signal (not shown), wherein each of the counters triggers assertion of a corresponding signal in response to the counter's value reaching a threshold (e.g. zero). The signal from each counter thus indicates expiration of a particular length of time, wherein the length of time is based on the relationship between the counter's threshold and a programmable reset value for the counter. As described further herein, the timers 322 are employed to trigger various periodic events, including the timing of when the power control module 102 determines whether to increase or decrease the number of active ones of the CUs 111.

The control module 325 is generally configured to periodically identify the processing load of the GPU 100. Based on this processing load, the control module 325 determines whether to increase or decrease the number of active CUs, and sends control signaling to the power and clock gating module 105 to effectuate the increase or decrease. In the depicted example, the control module 325 stores an adjustable value, referred to as a decrement score 326, to facilitate determination of whether to increase or decrease the number of active CUs.

To illustrate, in operation one of the timers 322 periodically sends a signal to the control module 325 to indicate that it is time to make a decision whether to increase or decrease the number of active CUs. In response, the control module 325 accesses one of more registers of the performance monitor 320 to determine the current processing load at the GPU 100 and the expected future processing load at the GPU 100. For example, the control module 325 can access registers indicating the number of cycles that the ALUs and TMUs of one or more of the active ones of CUs 111 are stalled to identify the current processing load, and can access registers indicating the number or size of threads buffered at the scheduler 104 to identify the expected future processing load. The control module 325 determines gradients for each of the current processing load and future processing loads and compares the gradients to corresponding thresholds stored at the threshold registers 321. The comparison indicates whether the processing load is increasing or decreasing, or expected to increase or decrease in the near future. If the comparison indicates a processing load increase, the control module 325 can immediately send control signaling to the power and clock gating module 105 to increase the number of activated ones of the CUs 111. If the comparison indicates a processing load decrease, the control module 325 increases the decrement score 326, and compares the resulting score to a corresponding threshold (referred to for purposes of description as a “decrement threshold”) stored at the threshold registers 321. If the decrement score exceeds the decrement threshold, the control module 325 sends control signaling to the power and clock gating module 105 to decrease the number of active ones of the CUs. The decrement threshold is a programmable value that can be adjusted during, for example, design or use of the electronic device incorporating the GPU 100. The decrement score 326 and decrement threshold together ensure that the power control module 102 is not too sensitive to short-term decreases in processing load at the GPU 100. Such sensitivity can cause reduction in performance at the GPU 100, and potentially cause an increase in power consumption due to the power costs of switching in and out of active and low-power modes.

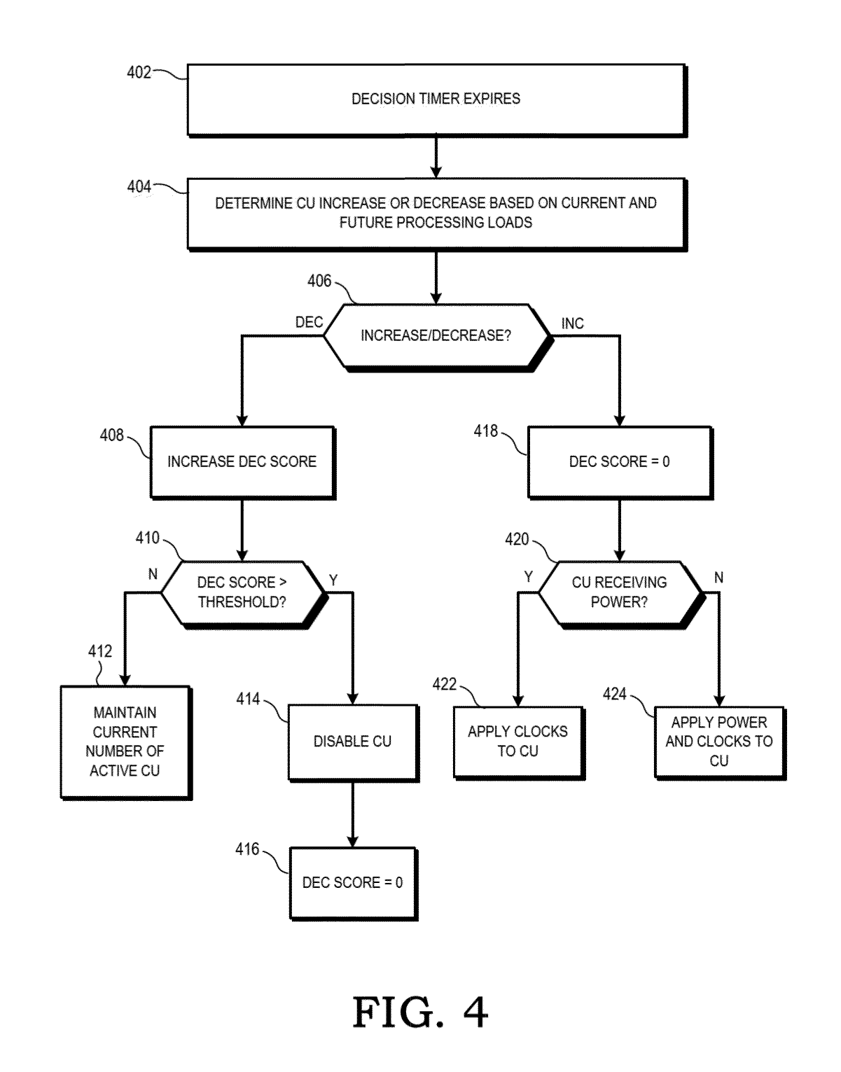

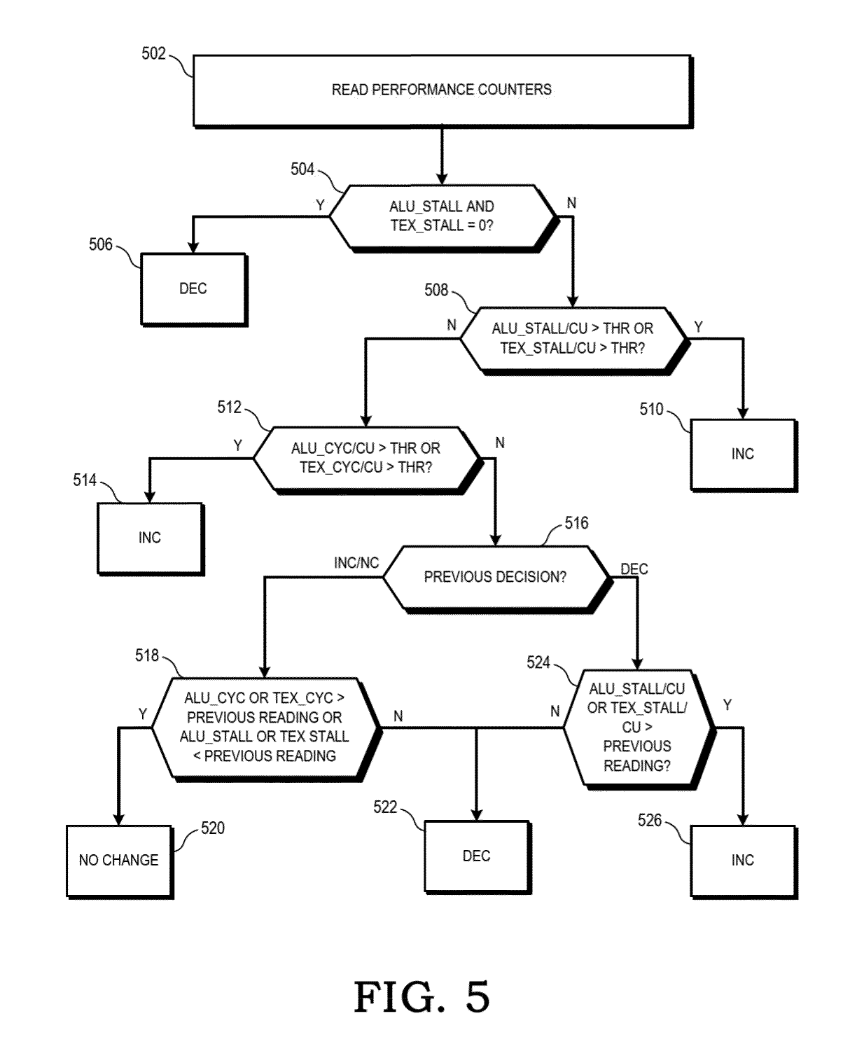

FIG. 4 is a flow diagram of a method of enabling and disabling CUs at the GPU 100 of FIG. 1 in accordance with some embodiments. At block 402, a specified timer (referred to as a “decision timer”) of the timers 322 (FIG. 3) expires, indicating that it is time for the control module 325 to determine whether to increase the number of active. ones of the CUs 111, decrease the number of active .CUs or leave the number of active CUs the same. At block 404, the control module 325 makes a decision whether to increase or decrease the number of active CUs based on the current processing load and the expected future processing load at the GPU 100. In some embodiments, the control module 325 makes the decision according to the method described below with respect to FIG. 5.

At block 406, the control module 325 determines whether the decision is to increase or decrease the number of active CUs. In some embodiments the control module 325 may decide to leave the number of active CUs the same, in which case the method. flow returns to block 402 and the control module 325 awaits the next expiration of the decision timer. If at block 406, the control module 325 determines that the decision is to decrease the number of active CUs, the method flow proceeds to block 408 and the control module 325 increments the decrement score 326. At block 410, the control module 325 determines whether the decrement score 326 is greater than a corresponding threshold stored at the threshold registers 321. If the decrement score 326 is not greater than the threshold, the method flow moves to block 412 and the control module 325 leaves the number of active CUs unchanged. In some embodiments, the method flow returns to block 402 and the control module 325 awaits the next expiration of the decision timer.

If at block 410, the decrement score 326 is greater than the threshold, the method flow moves to block 414 and the control module 325 sends control signaling to the power and clock gating module 105 to place an active CU into one of the low-power modes, thus disabling that CU. At block 416, the control module 325 resets the decrement score 326 to an initial value (zero in the depicted example). In some embodiments, the method flow returns to block 402 and the control module 325 awaits the next expiration of the decision timer.

Returning to block 406, if the control module 325 determines that the decision is to increase the number of active CUs, the method flow proceeds to block 418 and the control module 325 resets the decrement score 326 to an initial value (zero in the depicted example). At block 420 the control module 325 selects an inactive CU and determines whether the selected CU is receiving power (i.e. whether the selected CU is in the power-gated mode or is in the clock-gated mode). If the selected CU is in the clock gated mode, the method flow proceeds to block 422 and the control module 325 sends control signaling to the power and clock gating module 105 to apply clock signals to the selected CU, thereby transitioning the selected CU to the active mode. If at block 420, the control module 325 determines that the selected CU is in the power-gated mode, the method flow moves to block 424 and the control module 325 sends control signaling to the power and clock gating module 105 to apply power and clock signals to the selected CU, thereby transitioning the selected CU to the active mode. From both of blocks 422 and 424, the method flow returns to block 402 and the control module 325 awaits the next expiration of the decision timer.

FIG. 5 illustrates a flow diagram of a method of determining whether to increase, decrease, or leave the same the number of active CUs at the GPU 100 in accordance with some embodiments. At block 502, the control module 325 (FIG. 3) reads, at the performance monitor, the performance counters indicating the number of stalled cycles (designated ALU_STALL) at one or more ALUs of the CUs 111, the number of stalled cycles (designated TMU_STALL) at one or more of the TMUs of the CUs 111, the number of active cycles (designated ALU_CYC) at the one or more ALUs, and the number of active cycles (designated TMU_CYC) at the one or more TMUs. In some embodiments, the performance counters indicate the number of idle and active cycles for the respective ALUs and TMUs of a single selected CU that is in the active mode.

At block 504, the control module 325 determines whether ALU_STALL and TMU_STALL are both equal to zero. In some embodiments, rather than comparing these values to zero, the control module 325 determines whether the values are equal to or less than a minimum threshold. If so, the method flow proceeds the block 506 and the control module 325 determines to decrease the number of active CUs at the GPU 100. If, at block 504, one or both of ALU_STALL and TMU_STALL are not equal to zero (or are not less than or equal to the minimum threshold), the method flow moves to block 508. At block 508, the control module 325 determines whether ALU_STALL/CU (that is, the value ALU_STALL divided by the number of CUs 111) is greater than a threshold value or TMU_STALL/CU is greater than a threshold value, wherein the threshold values can be different values. If either ALU_STALL/CU or TMU_STALL/CU are greater than their corresponding threshold values, the method flow moves to block 510 and the control module 325 decides to increase the number of active CUs. If, at block 508, neither ALU_STALL/CU nor TMU_STALL/CU is greater than their corresponding threshold values, the method flow moves to block 512.

At block 512 the control module 325 determines whether ALU_CYC/CU (that is, the value ALU_CYC divided by the number of CUs 111) is greater than a threshold value or TMU_CYC/CU is greater than a threshold value, wherein the threshold values can be different values. If either ALU_CYC/CU or TMU_CYC/CU are greater than their corresponding threshold values, the method flow moves to block 510 and the control module 325 decides to increase the number of active CUs. If, at block 508, neither ALU_CYC/CU nor TMU_CYC/CU is greater than their corresponding threshold values, the method flow moves to block 516.

At block 516, the control module 325 determines whether its most recent previous decision was to increase the number of active CUs, decrease the number of active CUs, or leave the number of active CUs the same. If the previous decision was to increase the number of active CUs or leave the number the same, the method flow proceeds to block 518 and the control module 325 determines whether ALU_CYC or TMU_CYC is greater than the corresponding values when the previous decision was made and whether ALU_STALL or TMU_STALL is greater than the corresponding values when the previous decision was made. If at least one of ALU_CYC, TMU_CYC, ALU_STALL or TMU_STALL is greater than the corresponding value when the previous decision was made, the method flow moves to block 520 and the control module 325 determines to not change the number of active CUs. If, at block 518, none of ALU_CYC, TMU_CYC, ALU_STALL or TMU_STALL is greater than the corresponding value when the previous decision was made, the method flow moves to block 520 and the control module 325 decides to decrease the number of active CUs.

Returning to block 516, if the previous decision was to decrease the number of active CUs, the method flow moves to block 524. At block 324, the control module 325 determines whether either of ALU_STALL/CU or TMU_STALL/CU is greater than the corresponding value when the previous decision was made. If neither value is greater, the method flow moves to block 520 and the control module 325 decides to decrease the number of active CUs. If either of ALU_STALL/CU or TMU_STALL/CU is greater than the corresponding value when the previous decision was made, the method flow moves to block 526 and the control module 325 increases the number of active CUs.

In some embodiments, the apparatus and techniques described above are implemented in a system comprising one or more integrated circuit (IC) devices (also referred to as integrated circuit packages or microchips), such as the GPU described above with reference to FIGS. 1-5. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (RUM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

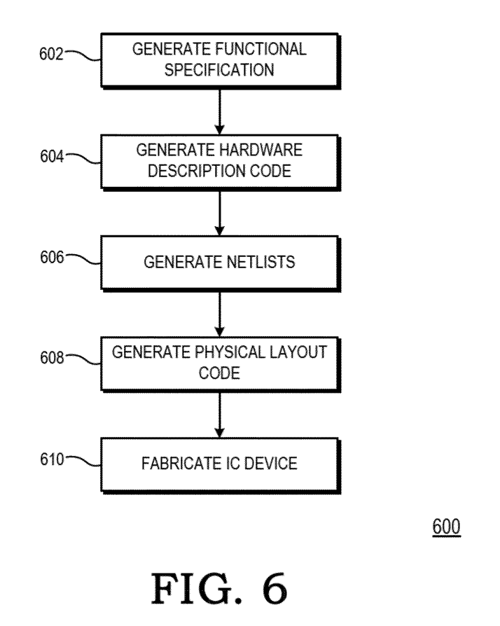

FIG. 6 is a flow diagram illustrating an example method 500 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code HMV include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, of essential feature of any of all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is clamed is:

1. A method comprising:
identifying, a first processing load at a graphics processing unit (GPU); and
disabling a first set of compute units (CUs) at the GPU based on the first processing load.

2. The method of claim 1, wherein identifying the first processing load comprises identifying the processing load based on a current processing load of the GPU and based on an expected future processing load of the GPU.

3. The method of claim 2, further comprising identifying the current processing load based on a number of stalled cycles of a first processing unit of the GPU.

4. The method of claim 3, wherein the first processing unit comprises an arithmetic logic unit (ALU) of the GPU.

5. The method of claim 3, wherein the first processing unit comprises a texture mapping unit of the GPU.

6. The method of claim 3, further comprising identifying the current processing load further based on a number of stalled cycles of a second processing unit of the GPU.

7. The method of claim 2, further comprising identifying the expected future processing. load of the GPU based on a number of threads scheduled to be executed at the GPU.

8. The method of claim 1, wherein identifying the first processing load comprises
identifying the first processing load at a first time, and further comprising:
identifying a second processing load at the GPU at a second time and
enabling a second set of CUs of the GPU based on the second processing load.

9. A method, comprising:
identifying a change in a processing load at a graphics processing unit (GPU) based on a current processing load of the GPU and an expected future processing load at the GPU; and
in response to identifying the change in the processing load at the GPU, changing a number of activated compute units (CUs) at the GPU.

10. The method of claim 9, further comprising:
identifying the current processing load of the GPU based on a ratio of stalled cycles of a processing unit of the GPU to a number of CUs at the GPU.

11. The method of claim 10, wherein the processing unit comprises an arithmetic logic unit (ALU) of the GPU.

12. The method of claim 10, wherein the processing unit comprises a texture mapping unit of the GPU.

13. The method of claim 10 further comprising identifying the expected future processing load at the GPU based on a number of threads scheduled for execution at the GPU.

14. A device, comprising:
a graphics processing unit (GPU) comprising:
a plurality of compute units (CUs);
a performance monitor to identify a change in processing load at the GPU based on a current processing load at the GPU and an expected future processing load at the GPU; and
a power control module to change a power mode of a CU of the plurality of CUs in response to the change in processing load at the GPU.

15. The device of claim 14, wherein the performance monitor identifies the processing load based on a current processing load of the GPU and based on an expected future processing load of the GPU.

16. The device of claim 15, wherein the performance monitor identifies the current processing load based on a number of stalled cycles of a first processing unit of the GPU.

17. The device of claim 16, wherein the first processing unit comprises an arithmetic logic unit (ALU) of the GPU.

18. The device of claim 16, wherein the first processing unit comprises a texture mapping unit of the GPU.

19. The device of claim 16, further comprising identifying the current processing load further based on a number of stalled cycles of a second processing unit of the GPU.

20. The device of claim 15, further comprising identifying the expected future processing load of the GPU based on a number of threads scheduled to be executed at the GPU.
